(19) United States
(12) Patent Application Publication
(10) Pub. No.: US 2004/0065029 A1
(43) Pub. Date: Apr. 8, 2004

(54) Removable portable window, or sliding door air filter

(76) Inventor: Marlina Morris, Los Angeles, CA (US)

Correspondence Address: MARLINA MORRIS, 10790 WILSHIRE BOULEVARD, #1004, LOS ANGELES, CA, 90024, US

(21) Appl. No.: 10/264,084

(22) Filed: Oct. 4, 2002

(51) Int. Cl. E06B 3/00; E06B 9/01

(52) U.S. Cl. 52/204.5; 52/204.6; 52/656.7

(57) ABSTRACT

A removable portable window filter (see FIG. 1) 2, which fits inside the partially opened window, or partially opened sliding glass door. The filter material 6, is attached between two narrow parallel metal bars 1, composing the Removable Portable Window Filter 2, which is removable when dirty for cleaning, and replacement.

### FIELD OF THE INVENTION

This invention relates to a adjustable, portable window filter, which will allow outside air to flow through the window, or sliding door opening, through the filter into the interior of a room.

### BACKGROUND OF THE INVENTION

People need to be able to open windows, and doors, and screens for fresher air circulation, without the accompanying dust and dirt. The present invention allows the air flow to be filtered, and captures most of the dust and dirt before it enters the interior of the room.

### SUMMARY OF THE INVENTION

This invention of a adjustable, portable window, or door, filter prevents most of the dust and dirt from entering a room, thus enhancing the health of occupants by reducing dust and dirt accumulation in the air, on furniture, walls, and drapes. This invention would also extend the life, and reduce the amount of cleaning of ones furniture, wall, and drapes. A further aspect of the present invention is that the window, or door filter is reusable after removal for easy cleaning.

### BRIEF DESCRIPTION OF THE DRAWINGS

FIG. 1

1 Shows the two metal supporting bars, or other rigid material, with the filter material in the middle ready for assembly.

2 Shows the assembled Removable Portable Window Air Filter ready to place in the window.

3 Shows the Removable Portable Window Air Filter installed in a window.

4 Shows the type of metal bar support, which folds over the filter material.

5 Shows the type of metal bar support, which has a rough side, which attaches to the filter material.

6 Shows the filter material in a roll, which dispenses the flat sheet, which can be cut to the desired length.

FIG. 2

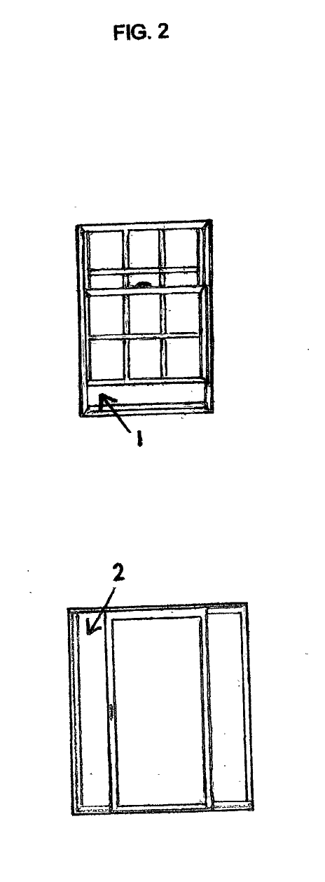

7 Shows another window style with the filter device in the bottom opening of the window.

8 Shows a sliding glass door with the adjustable window, or door, filter device installed on the left side of the opened door.

### DETAILED DESCRIPTION OF THE PREFERRED EMBODIMENT

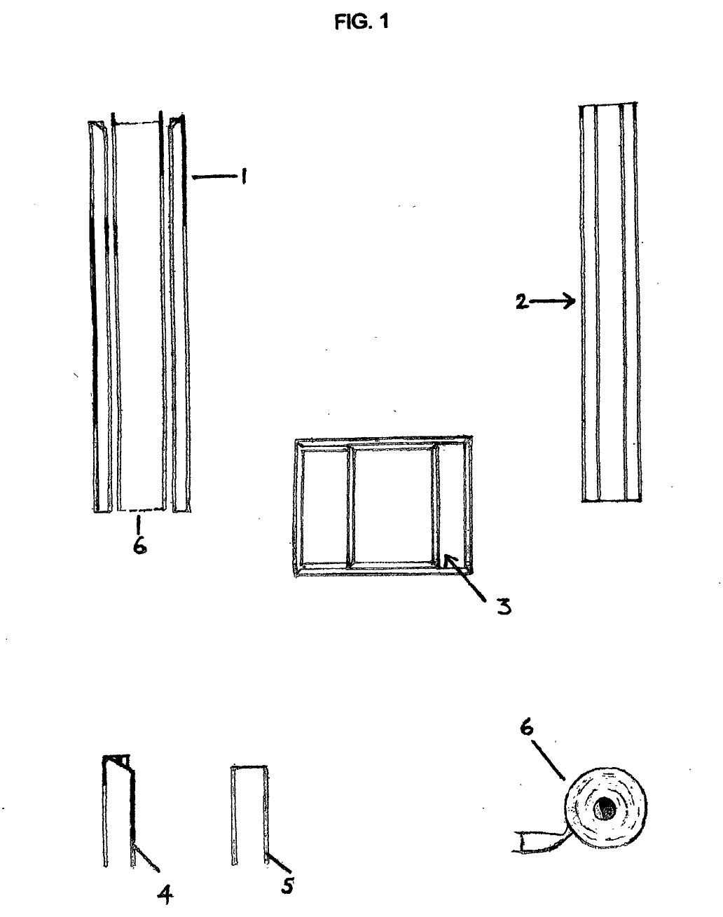

This invention is a portable adjustable air filtering device, (see FIG. 1) 2, which can be placed in open windows, or open sliding glass doors to filter dirt, dust, and prevent insects from entering a room by the outside air flow through normal building windows, or doors, either residential, or commercial.

Two lengths of metal bars, (see FIG. 1) 1, which support the filter material 6, are cut the desired length to fit inside the opening of the window casing 3, or door casing. The filter material 6, is placed in the middle and along the inner sides of the two metal bars 1, along the full length of the metal bars. If one is using the folding type of metal bar supports 4, press the open metal bar supports closing each side over the edges of the filter material 6, to secure the filter material in place. If using the straight flat metal bar supports with the rough irregular surface on one side 5, then press the filter material 6, firmly to attach it to the rough side of the narrow metal bars 5.

Take the two parallel metal bars (see FIG. 1) 1, which have been attached to the filter material 6, in both hands and place the assembled filter unit device 2, inside the casement grooves nearest the inner edges of the window, pushing the window, or sliding glass door to the edges of the removable portable air filter 2, which restricts the outside air flow from entering into the room; only flowing through the area of the open window covered by the filter device, 3.

### Embodiment

While emphasis has been placed herein on the structure and structural interrelationships between the component parts of the embodiment disclosed, it is possible that other embodiments of the invention can be made with many changes of the embodiment illustrated and described without departing from the principles of the invention. For instance the material for the bar supports can be made of any rigid material, and the filter material can be of any material which allows air to flow through it. Accordingly, the forgoing descriptive information is to be interpreted as illustrative of the present invention and not as a limitation.

What is claimed is:

1. The present invention provides a portable window, or door air filter, which filters outside air, and is comprised of two separated parallel rigid bar supports attached to the edges of the filter material in the middle.

2. The filter device according to claim 1 is adjustable in length and width to fit into a window, or a sliding door opening, and wherein the filter is adjustable it could be expanded for use as a screen, or filter covering the complete opening of a window, or sliding door.

3. The filter device according to claim 2 is adjustable and is reusable and easily cleaned.
